(19) United States
(12) Patent Application Publication
(10) Pub. No.: US 2012/0137528 A1
(43) Pub. Date: Jun. 7, 2012

(54) Laser Guided Striping Tool

(76) Inventor: Perry B. Bloodworth, Elbert, CO (US)

(21) Appl. No.: 13/309,388

(22) Filed: Dec. 1, 2011

Related U.S. Application Data
(60) Provisional application No. 61/419,132, filed on Dec. 2, 2010.

(51) Int. Cl. G01C 15/00

(52) U.S. Cl. 33/227

(57) ABSTRACT

A guidance system is used with a striping tool for creating a straight line on a surface. The guidance system has a dust resistant housing, a laser, a power supply, and a laser support arm. The dust resistant housing has an opening through which a laser beam may pass. The laser is disposed within the housing and aligned such that a beam from the laser will pass through the opening. The power supply provides power to the laser. The laser support arm is pivotally affixed to the striping tool. The housing is affixed to the arm such that the laser within the housing is aligned to pivot in a plane perpendicular to the surface and along a straight line created by the striping tool. The arm is pivotal to allow projection of a beam from the laser to the surface in the direction of movement of the striping tool.

This application claims the benefit of U.S. Provisional Application No. 61/419,132 filed Dec. 2, 2010.

### BACKGROUND

A variety of tools may be used to create a straight line on a surface. Straight lines may be created by cutting the surface or applying paint or chalk to the surface. Many techniques have been used to ensure that the line is, in fact, straight. The shortcoming of these techniques is often that when the tool for creating the line nears the edge of the surface they can no longer be used and the operator of the tool must apply the line without guidance.

### DESCRIPTION OF THE DRAWINGS

FIG. 1 is an illustration of one embodiment of the present invention laser guided striping system.

FIG. 2 is a cross-section view of one embodiment of the laser and housing of the present invention.

FIG. 3 is a cross-section view of another embodiment of the laser and housing of the present invention.

### DETAILED DESCRIPTION

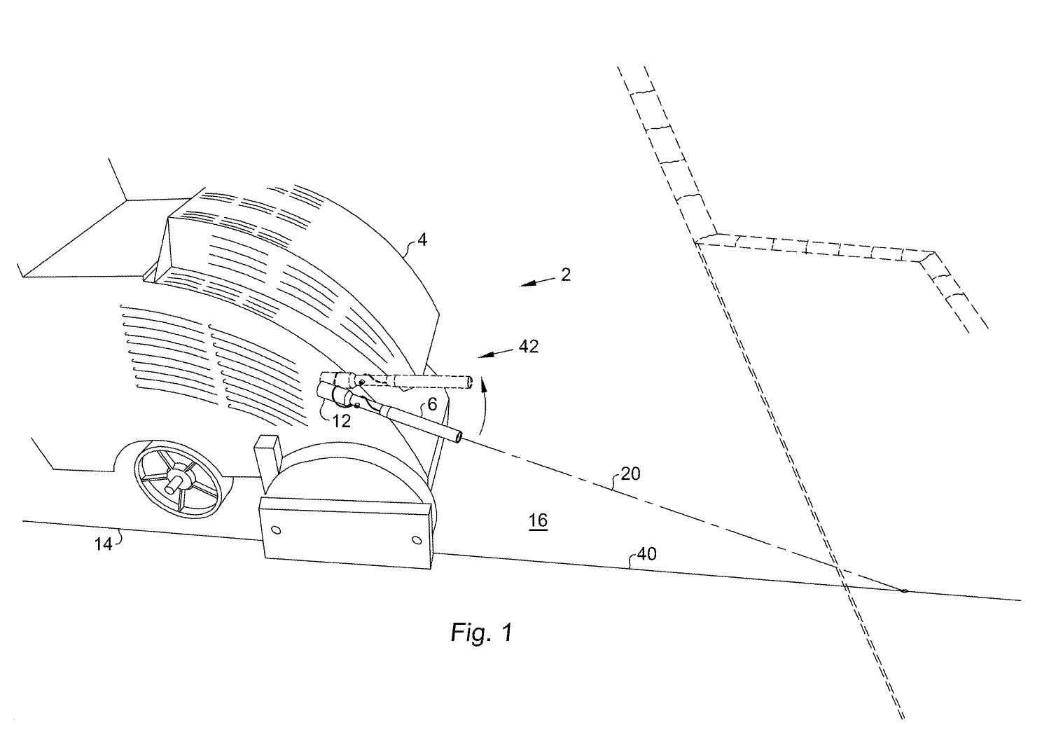

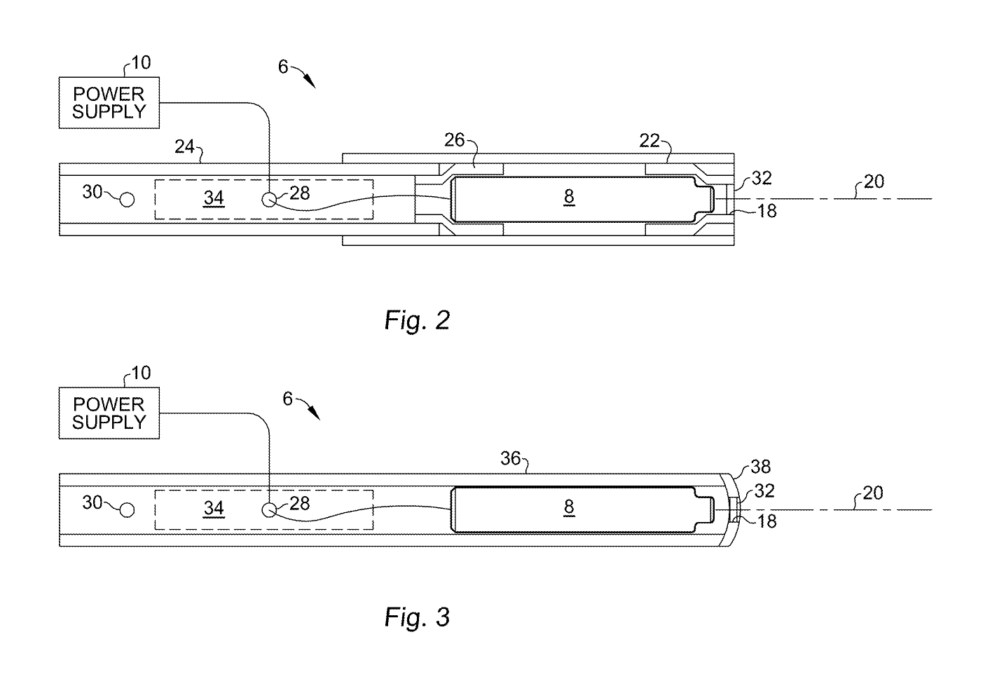

FIG. 1 shows an embodiment of the present invention laser guided striping system 2. Laser guided striping system 2 includes striping tool 4 and guidance system 42. Guidance system 42 includes dust resistant housing 6, laser 8 (FIG. 2), power supply 10, and laser support arm 12.

Striping tool 4 is any tool for creating a straight line 14 on a surface 16. Striping tool 4 may be a walk-behind tool either self propelled or manually driven, or a vehicle-type tool. Examples of striping tool 4 include a concrete saw for making linear cuts 14 in concrete 16; a painting tool for painting stripes 14 on pavement 16 or athletic courts 16; and a chalk dispensing tool for forming chalk lines 14 on athletic fields 16.

Dust resistant housing 6 may take any shape suitable for connection to striping tool 4. FIG. 2 illustrates one embodiment of dust resistant housing 6 of the present invention. A cross-section view of housing 6 and laser 8 is shown according to an exemplary embodiment of the present invention. In one embodiment, housing 6 is a hollow cylindrical housing. An opening 18 is formed in one end of dust resistant housing 6, through which a laser beam 20 may pass. A first end of the housing 6 may be capped by a laser end cap 22. A connecting tube 24 may be slidably disposed within the protective housing 6 from a second end. A laser base stop 26 may be attached inside at a first end of the connecting tube 24. The laser base stop 26 is a reducing fitting where the reduced end may be oriented similarly to the orientation of the second end of the protective housing 6. A wiring eyelet 28 may be formed about the middle of the connecting tube 24 to provide a wiring channel for power leads (not shown). A fastening hole 30 may be formed about an inch from a second end of the connecting tube 24 to allow housing 6 to be attached to a frame of striping tool 4. The second end of the connecting tube 24 may be fabricated with different shapes, for example, reduced, expanded, flattened, or angled to fit specific mounting applications.

A laser 8 may be fitted inside the protective housing 6. Laser 8 is disposed within housing 6 and aligned such that a beam 20 from laser 8 will pass through the opening 18. The laser 8 may be an off the shelf preassembled cylindrical module. A nearly flat end of the laser 8 may be disposed within the laser base stop 26. The other end of the laser 8 may have a tapered end and may be captured by the laser end cap 22. A tip of the laser 8 may be positioned just below flush with the protective housing 6. The laser 8 may be configured with different focusing adaptor that may project specific illumination patterns, for example, continuous or dotted vertical or horizontal lines in various lengths, cross hair patterns, etc. The laser 8 may be operated on a 6 Volt or 12 Volt battery power supply 10, as required by the laser 8. Power supply 10 is in communication with laser 8, for providing power to laser 8. Power supply 10 may be integral to striping tool 4 or separate from striping tool 4. Laser 8 may emit either a red or a green beam, depending on the laser 8.

Optional rubber gaskets (not shown) may be fitted between the laser 8 and the laser end cap 22 and the base stop 26 respectively to ensure that the laser 8 is seated snugly and securely, which may prevent undesirable vibrations to occur. A lens 32 may be attached over the end of the laser end cap 22 to prohibit water or dust from entering protective housing 6. In one embodiment, a focusing adaptor (not shown) may cover opening 18 in housing 6 to project an illumination pattern.

A space 34 available between the laser base stop 26 and the second end of the connecting tube 24 may be used as an enclosure to various electrical components, for example, a toggle switch to connect a 12 Volt battery (not shown) to the laser 8, an in-line fuse (not shown), various wirings, and connectors.

The components of housing 6 and arm 12 may be manufactured from metal tubing, for example, copper or aluminum, or injection molded plastic material.

FIG. 3 illustrates an alternate embodiment of the dust resistant housing 6. In this embodiment, housing 6 is a single tube 36. Tube 36 is covered by a cap 38 with an opening 18 formed therein. Lens 32 may be inserted into opening 18. Alternatively, (not shown) lens 32 may be omitted and the tip of laser 8 may be inserted through opening 18.

Laser support arm 12 is pivotally affixed to striping tool 4. Housing 6 is affixed to arm 12 such that laser 8 within housing 6 is aligned to pivot in a plane perpendicular to surface 16 and along straight line 14 created by striping tool 4. Arm 12 is pivotal to allow projection of a beam from laser 8 to surface 16 in the direction of movement of striping tool 4.

In one embodiment, arm 12 is further pivotal to allow projection of a beam from laser 8 to a point above surface 16 in the direction of movement of striping tool 4, wherein maintaining laser beam 20 at the point as striping tool 4 is moved toward the point creates straight line 14 on surface 16.

In one embodiment, laser beam 20 is maintained on a guide line 40 on surface 16 as striping tool 4 is moved along guide line 40 to create straight line 14 on surface 16.

The foregoing description is only illustrative of the invention. Various alternatives and modifications can be devised by those skilled in the art without departing from the invention. Accordingly, the present invention embraces all such alternatives, modifications, and variances that fall within the scope of the appended claims.

What is claimed is:

1. A laser guided striping system comprising:
a striping tool for creating a straight line on a surface;
a dust resistant housing having an opening through which a laser beam may pass;
a laser disposed within the housing and aligned such that a beam from the laser will pass through the opening;
a power supply in communication with the laser, for providing power to the laser;
a laser support arm pivotally affixed to the striping tool; and
wherein the housing is affixed to the arm such that the laser within the housing is aligned to pivot in a plane perpendicular to the surface and along a straight line created by the striping tool, the arm pivotal to allow projection of a beam from the laser to the surface in the direction of movement of the striping tool.

2. The laser guided striping system of claim 1 wherein the arm is further pivotal to allow projection of a beam from the laser to a point above the surface in the direction of movement of the striping tool, wherein maintaining the laser beam at the point as the striping tool is moved toward the point creates a straight line on the surface.

3. The laser guided striping system of claim 1 wherein maintaining the laser beam on a guide line on the surface as the striping tool is moved along the guide line creates a straight line on the surface.

4. The laser guided striping system of claim 1 further including a lens covering the opening in the housing.

5. The laser guided striping system of claim 1 further including a focusing adaptor covering the opening in the housing and configured to project an illumination pattern.

6. The laser guided striping system of claim 1 wherein the dust resistant housing includes:
a hollow cylindrical protective housing having one end capped by a laser end cap;
a connecting tube slidably disposed within the protective housing;
a laser base stop attached inside the connecting tube; and
wherein the laser is fitted inside the protective housing between the base cap and the laser end cap.

7. The laser guided striping system of claim 1 wherein the laser module has an outer dimension, a laser emitting tip at one end, and a base at an end opposite the laser emitting tip and wherein the dust resistant housing includes:
a linear protective housing tube having a proximal end and a distal end with a first opening formed in the proximal end and a second opening formed in the distal end;
a laser base stop and a laser end cap each having a large dimension opening, a small dimension opening, and a sloped section interconnecting the large dimension opening and the small dimension opening, the large dimension opening having an outer dimension less than the inner dimension of the housing tube and an inner dimension greater than the outer dimension of the laser module, the small dimension opening having an inner dimension less than the outer dimension of the laser module, the base stop disposed within the housing tube with the large dimension surrounding the base of the laser module and the small dimension opening projecting towards the proximal end of the housing tube, the end cap affixed within the housing tube with the small dimension opening near the distal end of the housing tube and the large dimension opening projecting into the housing tube and surrounding the laser emitting tip of the laser module; and
a linear connecting tube having an outer dimension less than the inner dimension of the housing tube and an inner dimension greater than the outer dimension of the small dimension opening of the base stop, one end of the connecting tube disposed within the housing tube abutting the base stop and surrounding the small dimension opening of the base stop.

8. A guidance system for a striping tool for creating a straight line on a surface, guidance system comprising:
a dust resistant housing having an opening through which a laser beam may pass;
a laser disposed within the housing and aligned such that a beam from the laser will pass through the opening;
a power supply in communication with the laser, for providing power to the laser;
a laser support arm pivotally affixed to the striping tool; and
wherein the housing is affixed to the arm such that the laser within the housing is aligned to pivot in a plane perpendicular to the surface and along a straight line created by the striping tool, the arm pivotal to allow projection of a beam from the laser to the surface in the direction of movement of the striping tool.

9. The guidance system of claim 8 wherein the arm is further pivotal to allow projection of a beam from the laser to a point above the surface in the direction of movement of the striping tool, wherein maintaining the laser beam at the point as the striping tool is moved toward the point creates a straight line on the surface.

10. The guidance system of claim 8 wherein maintaining the laser beam on a guide line on the surface as the striping tool is moved along the guide line creates a straight line on the surface.

11. The guidance system of claim 8 further including a lens covering the opening in the housing.

12. The guidance system of claim 8 further including a focusing adaptor covering the opening in the housing and configured to project an illumination pattern.

13. The guidance system of claim 8 wherein the dust resistant housing includes:
a hollow cylindrical protective housing having one end capped by a laser end cap;
a connecting tube slidably disposed within the protective housing;
a laser base stop attached inside the connecting tube; and
wherein the laser is fitted inside the protective housing between the base cap and the laser end cap.

14. The guidance system of claim 8 wherein the laser module has an outer dimension, a laser emitting tip at one end, and a base at an end opposite the laser emitting tip and wherein the dust resistant housing includes:
a linear protective housing tube having a proximal end and a distal end with a first opening formed in the proximal end and a second opening formed in the distal end;
a laser base stop and a laser end cap each having a large dimension opening, a small dimension opening, and a sloped section interconnecting the large dimension opening and the small dimension opening, the large dimension opening having an outer dimension less than the inner dimension of the housing tube and an inner dimension greater than the outer dimension of the laser module, the small dimension opening having an inner dimension less than the outer dimension of the laser module, the base stop disposed within the housing tube with the large dimension surrounding the base of the laser module and the small dimension opening projecting towards the proximal end of the housing tube, the end cap affixed within the housing tube with the small dimension opening near the distal end of the housing tube and the large dimension opening projecting into the housing tube and surrounding the laser emitting tip of the laser module; and
a linear connecting tube having an outer dimension less than the inner dimension of the housing tube and an inner dimension greater than the outer dimension of the small dimension opening of the base stop, one end of the connecting tube disposed within the housing tube abutting the base stop and surrounding the small dimension opening of the base stop.
